(19) United States
(12) Patent Application Publication
(10) Pub. No.: US 2016/0103670 A1
(43) Pub. Date: Apr. 14, 2016

(54) FIRMWARE UPDATING METHOD AND ELECTRONIC APPARATUS USING THE SAME

(71) Applicant: Transcend Information, Inc., Taipei City (TW)

(72) Inventors: Kuan-Jen CHEN, Yilan County (TW); Chia-Ming HU, New Taipei City (TW)

(21) Appl. No.: 14/509,068

(22) Filed: Oct. 8, 2014

(51) Int. Cl. G06F 9/445

(52) U.S. Cl. CPC G06F 8/65

(57) ABSTRACT

The disclosure discloses a firmware updating method for updating a main firmware component of an electronic apparatus electrically connected with a removable memory device. The method includes: (a) performing a firmware updating procedure to copy a firmware updating component from the removable memory device to the electronic apparatus, and to update the main firmware component by using the firmware updating component in the removable memory device; (b) deleting the firmware updating component and then rebooting the electronic device if the firmware updating procedure is successfully finished, or directly rebooting the electronic device if the firmware updating procedure is unsuccessfully finished; (c) determining whether the firmware updating component exists in the removable memory device after rebooting the electronic apparatus; and (d) sequentially performing the steps (a) to (c) again if the firmware updating component exists in the removable memory device in the step (c).

### BACKGROUND

1. Technical Field

The present disclosure relates to a firmware updating method and an electronic apparatus using such method.

2. Description of Related Art

An embedded device is a computer system where all necessary hardware and mechanical components for achieving a specific purpose are integrated into a dedicated hardware assembly. The executable code in an embedded system is referred to as “firmware.” The firmware is written to non-volatile storage, such as flash storage or other block-based, electrically erasable, programmable random access memory (EEPROM) technology.

It is common practice to update the firmware in these devices in the field without using any special hardware. The firmware is either read from a removable media or received over a communication path from another microprocessor-based system. The act of updating firmware in an embedded device involves the embedded device erasing a block of storage, and then writing that storage with replacement firmware. A block can store a significant portion of the overall executable firmware. The replacement firmware is read from a removable media (e.g., a memory card) or a communication stream from an external system.

However, during the updating procedure, if power is removed or communication with the external system or removable media is lost, the device is left without valid firmware, and therefore may be in an unusable state. As a consequence, the device needs to be returned to a service center, or discarded.

Accordingly, how to provide a firmware updating method and an electronic apparatus using the method to solve the aforementioned problems becomes an important issue to be solved by those in the industry.

### SUMMARY

The disclosure provides a firmware updating method for updating a main firmware component of an electronic apparatus electrically connected with a removable memory device. The firmware updating method includes: (a) performing a firmware updating procedure to copy a firmware updating component from the removable memory device to the electronic apparatus, and to update the main firmware component by using the firmware updating component; (b) deleting the firmware updating component and then rebooting the electronic device if the firmware updating procedure is successfully finished, or directly rebooting the electronic device if the firmware updating procedure is unsuccessfully finished; (c) determining whether the firmware updating component exists in the removable memory device after rebooting the electronic apparatus; and (d) sequentially performing the steps (a) to (c) again if the firmware updating component exists in the removable memory device in the step (c).

In an embodiment of the disclosure, the step (b) further includes: rebooting the electronic apparatus based on the updated main firmware component if the firmware updating procedure is uccessfully finished.

In an embodiment of the disclosure, the step (b) further includes: rebooting the electronic apparatus based on the copied firmware updating component if the firmware updating procedure is unsuccessfully finished.

In an embodiment of the disclosure, the electronic apparatus is rebooted automatically if the firmware updating procedure is successfully finished, and the electronic apparatus is rebooted manually if the firmware updating procedure is unsuccessfully finished.

In an embodiment of the disclosure, the removable memory device is a flash memory card or an external hard drive.

The disclosure further provides a firmware updating method for updating a main firmware component of an electronic apparatus electrically connected with a removable memory device. The firmware updating method includes: (a) performing a firmware updating procedure to update the main firmware component by using a firmware updating component in the removable memory device; (b) deleting the firmware updating component and then rebooting the electronic device if the firmware updating procedure is successfully finished, or directly rebooting the electronic device if the firmware updating procedure is unsuccessfully finished; (c) determining whether the firmware updating component exists in the removable memory device after rebooting the electronic apparatus ; and d) sequentially performing the steps (a) to (c) again if the firmware updating component exists in the removable memory device in the step (c).

In an embodiment of the disclosure, the step (b) further includes: rebooting the electronic apparatus based on the updated main firmware component if the firmware updating procedure is successfully finished.

In an embodiment of the disclosure, the step (b) further includes: rebooting the electronic apparatus based on the firmware updating component in the removable memory device if the firmware updating procedure is unsuccessfully finished.

In an embodiment of the disclosure, the electronic apparatus is rebooted automatically if the firmware updating procedure is successfully finished, and the electronic apparatus is rebooted manually if the firmware updating procedure is unsuccessfully finished.

The disclosure further provides an electronic apparatus. The electronic apparatus includes a memory module and a processor. The memory module stores a boot code component and a main firmware component. The processor is configured to perform a firmware updating procedure to update the main firmware component by using a firmware updating component. The processor is further configured to delete the firmware updating component and then reboots the electronic device if the firmware updating procedure is successfully finished, or configured to directly rebooting the electronic device by manual means if the firmware updating procedure is unsuccessfully finished. The processor is further configured to determine whether the firmware updating component is presence after rebooting the electronic apparatus. The processor is further configured to sequentially perform the firmware updating procedure again by using the firmware updating component if the firmware updating component is presence after rebooting the electronic apparatus.

In an embodiment of the disclosure, the electronic apparatus is rebooted automatically if the firmware updating procedure is successfully finished, and the electronic apparatus is rebooted manually if the firmware updating procedure is unsuccessfully finished.

In an embodiment of the disclosure, the processor is further configured to reboot the electronic apparatus by using the boot code component which recognizes the updated main firmware component in the memory module if the firmware updating procedure is successfully finished.

In an embodiment of the disclosure, the firmware updating component is stored in a removable memory device. The electronic apparatus is able to be rebooted by using the boot code component of the removable memory device when the removable memory device is connected to the electronic apparatus, and a recognizing priority level of the firmware updating component is higher then the main firmware component.

In an embodiment of the disclosure, the processor is further configured to reboot the electronic apparatus by using the boot code component which recognizes the firmware updating component in the removable memory device if the firmware updating procedure is unsuccessfully finished.

In an embodiment of the disclosure, the processor is further configured to copy the firmware updating component from the removable memory device to the electronic apparatus first when the processor performs the firmware updating procedure, so as to reboot the electronic apparatus by using the boot code component which recognizes the copied firmware updating component in the electronic apparatus if the firmware updating procedure is unsuccessfully finished.

In an embodiment of the disclosure, the processor is further configured to delete both the firmware updating component and the copied firmware updating component and then reboot the electronic device by using the boot code component which recognizes the updated main firmware component in the memory module if the firmware updating procedure is successfully finished.

In an embodiment of the disclosure, the processor is further configured to determine whether at least one of the firmware updating component and the copied firmware updating component is presence after rebooting the electronic apparatus.

In an embodiment of the disclosure, the processor is further configured to sequentially perform the firmware updating procedure again by using the firmware updating component if at least one of the firmware updating component and the copied firmware updating component is presence after rebooting the electronic apparatus.

In an embodiment of the disclosure, the memory module includes a first memory unit and a second memory unit. The boot code component and the main firmware component are stored in the first memory unit. The copied firmware updating component is stored in the second memory unit.

Accordingly, the firmware updating method of the disclosure provides an active-rescue approach for an electronic apparatus when the firmware updating procedure is unsuccessfully finished. Particularly, according to the firmware updating method, a firmware updating component in the removable memory device will be deleted if the firmware updating procedure is successfully finished, and the firmware updating procedure will be performed again if the firmware updating component still exists in the removable memory device after the electronic apparatus rebooted. In other words, if the firmware updating component still exists in the removable memory device rather than being deleted after the electronic apparatus is rebooted, the firmware updating procedure will be repeatedly performed until successfully finished. As a result, the electronic apparatus can be actively rescued after the failure of the firmware updating procedure occurs by using the firmware updating method of the disclosure,

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an electronic apparatus electrically connected with a removable memory device according to an embodiment of the disclosure;

FIG. 2 is a flow diagram of a firmware updating method according to an embodiment of the disclosure; and

FIG. 3 is a flow diagram of a firmware updating method according to another embodiment of the disclosure.

### DETAILED DESCRIPTION

Reference will now be made in detail to the present embodiments of the disclosure, examples of which are illustrated in the accompanying drawings. Wherever possible, the same reference numbers e used in the drawings and the description to refer to the same or like parts

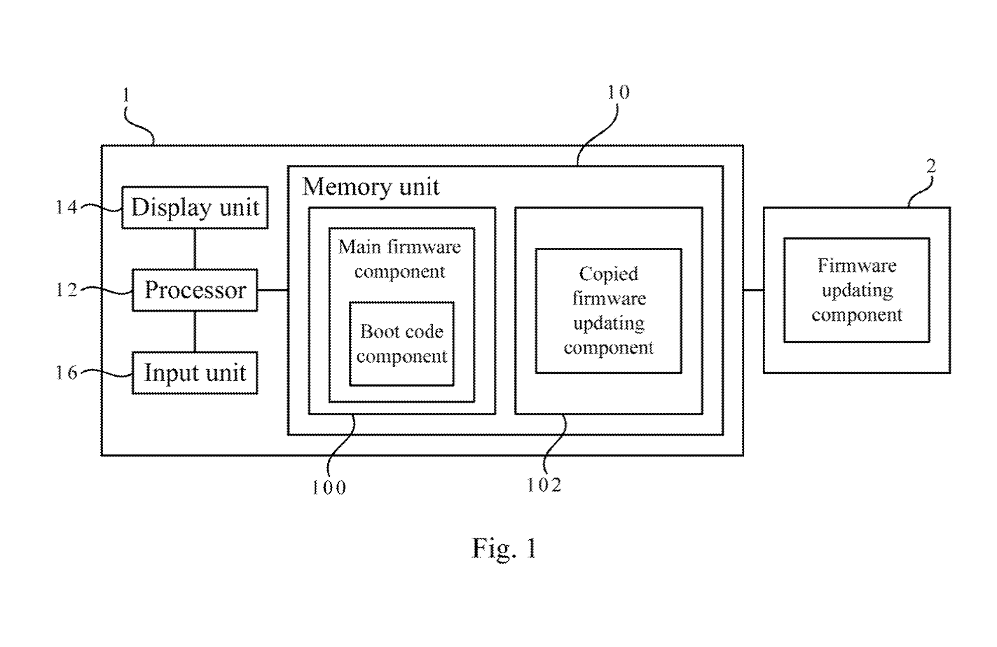

FIG. 1 is a schematic diagram of an electronic apparatus 1 electrically connected with a removable memory device 2 according to an embodiment of the disclosure. As shown in FIG. 1, the electronic apparatus 1 includes a memory module 10, a processor 12, a display unit 14, and an input unit 16. The electronic apparatus 1 can be electrically connected with a removable memory device 2. In detail, the electronic apparatus 1 has a connection socket (not shown) configured to be detachably connected with the removable memory device 2. The processor 12 is electrically connected to the memory module 10, the display unit 14, and the input unit 16. The memory module 10 includes a first memory unit 100 and a second memory unit 102. The first memory unit 100 of the memory module 10 stores a boot code component and a main firmware component. The processor 12 is configured to make the display unit 14 display a user interface and to operate the user interface through the input unit 16. A firmware updating component is stored in the removable memory device 2. The functions of the electronic apparatus 1 are described in more detail below.

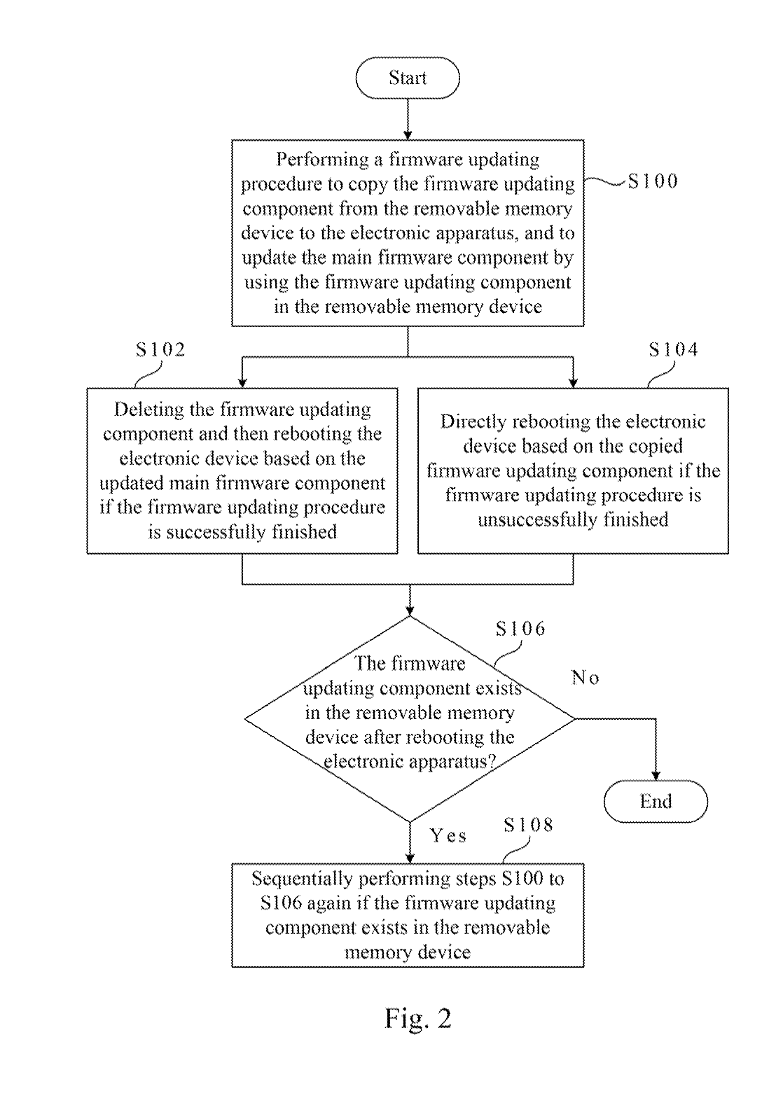

FIG. 2 is a flow diagram of a firmware updating method according to an embodiment of the disclosure. As shown in FIG. 2, the firmware updating method includes steps S100˜S108 which are also shown below.

Step S100: performing a firmware updating procedure to copy the firmware updating component from the removable memory device to the electronic apparatus, and to update the main firmware component by using the firmware updating component in the removable memory device.

As shown in FIG. 1, in the embodiment, when a user want to update the firmware of the electronic apparatus 1, the user can generate a firmware updating signal by using the input unit 16. The processor 12 can perform the firmware updating procedure according to the firmware updating signal, so as to copy the firmware updating component to the second memory unit 102 of the memory module 10 and update the main firmware component in the first memory unit 100 by using the firmware updating component in the removable memory device.

Step S102: deleting the firmware updating component and then rebooting the electronic apparatus based on the updated main firmware component if the firmware updating procedure is successfully finished.

Step S104: directly rebooting the electronic device based on the copied firmware component if the firmware updating procedure is unsuccessfully finished.

In the embodiment, the processor 12 is configured to delete the firmware updating component in the removable memory device 2 and the copied firmware updating component in the second memory unit 102 by using the updated main firmware component. That is, the processor 12 can delete the firmware updating component in the removable memory device 2 and the copied firmware updating component in the second memory unit 102 if the firmware updating procedure is successfully finished.

In other words, at least one of the absences of the firmware updating component in the removable memory device 2 and the copied firmware updating component in the second memory unit 102 after the electronic apparatus 1 is rebooted represent that the firmware updating procedure is successfully finished. After the firmware updating component is successfully copied to the second memory unit 102 and updates the main firmware component, the updated main firmware component has a new version.

In the embodiment, the processor 12 is configured to reboot the electronic apparatus 1 by using the boot code component which recognizes the updated main firmware component in the first memory unit 100 if the firmware updating procedure is successfully finished. The processor 12 is further configured to reboot the electronic apparatus 1 by using the boot code component which recognizes the firmware updating component in the removable memory device 2 if the firmware updating procedure is unsuccessfully finished.

Step S106: determining whether the firmware updating component exists in the removable memory device after ebooting the electronic apparatus.

In the embodiment, the processor 12 can further determine whether the firmware updating procedure is successfully finished by determining whether the firmware updating component exists in the removable memory device 2 after rebooting the electronic apparatus 1. If the firmware updating component does not exist in the removable memory device 2, the processor 12 determines the firmware updating procedure to be successfully finished. If the firmware updating component exists in the removable memory device 2, the processor 12 determines the firmware updating procedure to be unsuccessfully finished In another embodiment, the processor 12 can further determine whether the firmware updating procedure is successfully finished by determining whether the firmware updating component exists in the removable memory device 2 or determining whether the copied firmware updating component exists in the second memory unit 102 after rebooting the electronic apparatus 1. If the firmware updating component does not exist in the removable memory device 2 and the copied firmware updating component does not exists in the second memory unit 102, the processor 12 determines the firmware updating procedure to be successfully finished. If at least one of the firmware updating component and the copied firmware updating component exists, the processor 12 determines the firmware updating procedure to be unsuccessfully finished.

Step S108: sequentially performing the steps S100 to S106 again if the firmware updating component exists in the removable memory device in the step S106.

In the embodiment, with reference to FIG. 2, if the firmware updating component does not exist in the removable memory device 2 in the step S106, the firmware updating method of the disclosure is successfully finished.

On the contrary, if the determination in the step S106 is that the firmware updating component exists in the removable memory device 2, the processor 12 is configured to sequentially perform the firmware updating procedure by using the firmware updating component in the removable memory device 2 (Le., the step S100), delete the firmware updating component and the copied firmware updating component and then reboot the electronic apparatus by using the boot code component which recognizes the updated main firmware component if the firmware updating procedure is successfully finished (i.e., the step S102), and determine whether the firmware updating component exists in the removable memory device 2 after rebooting the electronic apparatus 1 (Le., the step S106) again. Or, the processor 12 is configured to sequentially perform the firmware updating procedure by using the firmware updating component in the removable memory device 2 (Le., the step S100), directly rebooting the electronic device 1 by using the boot code component if the firmware updating procedure is unsuccessfully finished (i.e., the step S104), and determine whether the firmware updating component exists in the removable memory device 2 after rebooting the electronic apparatus 1 (i.e., the step S106) again.

Therefore, the firmware updating method of the disclosure provides an active-rescue approach for the electronic apparatus 1 when the electronic apparatus 1 fails the firmware updating procedure. In detail, if the firmware updating component still exists in the removable memory device 2 after the electronic apparatus 1 is rebooted, the firmware updating procedure will be repeatedly performed until successfully finished.

In a practical scenario, if the electronic apparatus 1 crashes and it is not clear that whether the firmware updating procedure is successfully finished or not, the user can manually reboot the electronic apparatus 1 by pressing a power button (not shown) of the electronic apparatus 1. The processor 12 can then determine whether the firmware updating component exists in the removable memory device 2 after rebooting the electronic apparatus 1 It should be pointed out that a recognizing priority level of the firmware updating component is higher than the main firmware component. If the firmware updating procedure is successfully finished (i.e., the processor 12 determine that the firmware updating component exists in the removable memory device 2) before the electronic apparatus 1 is rebooted, the processor 12 will reboot the electronic apparatus 1 by using the boot code component which recognizes the updated main firmware component in the memory module 10 after the electronic apparatus 1 is rebooted. If the firmware updating procedure is unsuccessfully finished (i.e., the processor 12 determine that the firmware updating component does not exist in the removable memory device 2) before the electronic apparatus 1 is rebooted and the electronic apparatus 1 is memory card bootable, the processor 12 will reboot the electronic apparatus 1 by using the boot code component which recognizes the firmware updating component in the removable memory device 2 after the electronic apparatus 1 is rebooted. If the firmware updating procedure is unsuccessfully finished before the electronic apparatus 1 is rebooted and the electronic apparatus 1 is memory card unbootable, the processor 12 will reboot electronic apparatus 1 by using the boot code component which recognizes the copied firmware updating component in the second memory unit 102 after the electronic apparatus 1 is rebooted. That is, if the firmware updating component does not exist in the removable memory device 2 after the electronic apparatus 1 is rebooted, the absence of the firmware updating component in the removable memory device 2 represents that the firmware updating procedure has been successfully finished, and the firmware updating component in the removable memory device 2 and the copied firmware updating component in the second memory unit 102 have been deleted by the processor 12. If the firmware updating component still exists in the removable memory device 2 after the electronic apparatus 1 is rebooted, the processor 12 can sequentially perform the steps S100, S102, and S106 again if the firmware updating procedure is successfully finished, or sequentially perform the steps S100, S104, and S106 again if the firmware updating procedure is unsuccessfully finished.

In an embodiment, the electronic apparatus 1 is an event data recorder (EDR), but the disclosure is not limited in this regard.

In an embodiment, the memory module 10 is a flash memory, an electrically-erasable programmable read-only memory (EEPROM) etc but the disclosure is not limited in this regard.

In an embodiment, the processor 12 is a microprocessor, a microcontroller, an ASIC, etc., but the disclosure is not limited in this regard.

In an embodiment, the removable memory device 2 is a flash memory card (e.g., a TF flash memory card) or an external hard drive (e.g., a SSD hard drive), but the disclosure is not limited in this regard.

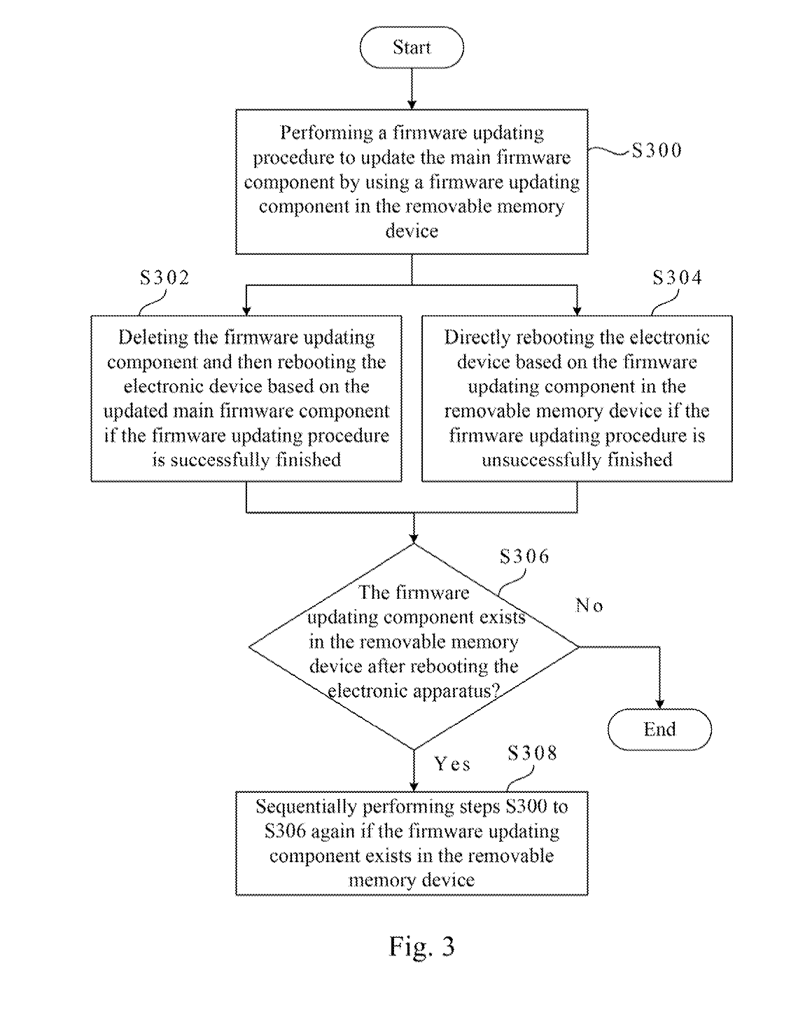

FIG. 3 is a flow diagram of a firmware updating method according to another embodiment of the disclosure. As shown in FIG. 3, the firmware updating method includes steps S300-S308 which are also shown below.

Step S300: performing a firmware updating procedure to update the main firmware component by using a firmware updating component in the removable memory device.

Step S302: deleting the firmware updating component and then rebooting the electronic device based on the updated main firmware component if the firmware updating procedure is successfully finished.

Step S304: directly rebooting the electronic device based on the firmware updating component in the removable memory device if the firmware updating procedure is unsuccessfully finished,

Step S306: determining a status of the firmware updating component exists in the removable memory device after rebooting the electronic apparatus.

Step S308: sequentially performing the steps S300 to S306 again if the firmware updating component exists in the removable memory device in the step S306.

With reference to FIG. 1, it should be pointed out that one difference between the present embodiment and the embodiment of FIG. 2 is that the firmware updating component in the removable memory device 2 is directly updated to the main firmware component without being copied to the second memory unit 102 in the present embodiment.

In a practical scenario, if the electronic apparatus 1 crashes and it is not clear that whether the firmware updating procedure is successfully finished or not, the user can manually reboot the electronic apparatus 1 by pressing a power button (not shown) of the electronic apparatus . The processor 12 can then determine whether the firmware updating component exists in the removable memory device 2 after rebooting the electronic apparatus 1, It should be pointed out that a recognizing priority level of the firmware updating component is higher than the main firmware component. If the firmware updating procedure is successfully finished (.e., the processor 12 determine that the firmware updating component exists in the removable memory device 2) before the electronic apparatus 1 is rebooted, the processor 12 will reboot the electronic apparatus 1 by using the boot code component which recognizes the updated main firmware component in the memory module 10 after the electronic apparatus 1 is rebooted. If the firmware updating procedure is unsuccessfully finished (Le., the processor 12 determine that the firmware updating component does not exist in the removable memory device 2) before the electronic apparatus 1 is rebooted, the processor 12 will reboot the electronic apparatus 1 by using the boot code component which recognizes the firmware updating component in the removable memory device 2 after the electronic apparatus 1 is rebooted. As a result, the electronic apparatus 1 of the embodiment must be memory card bootable. That is, if the firmware updating component does not exist in the removable memory device 2 after the electronic apparatus 1 is rebooted, the absence of the firmware updating component in the removable memory device 2 represents that the firmware updating procedure has been successfully finished and the firmware updating component in the removable memory device 2 has been deleted by the processor 12. If the firmware updating component still exists in the removable memory device 2 after the electronic apparatus 1 is rebooted, the processor 12 can sequentially perform the steps S300, S302, and S306 again if the firmware updating procedure is successfully finished, or sequentially perform the steps S300, S304, and S306 again if the firmware updating procedure is unsuccessfully finished.

According to the foregoing recitations of the embodiments of the disclosure, it can be seen that the firmware updating method of the disclosure provides an active-rescue approach for an electronic apparatus when the firmware updating procedure is unsuccessfully finished. Particularly, according to the firmware updating method, a firmware updating component in the removable memory device will be deleted if the firmware updating procedure is successfully finished, and the firmware updating procedure will be performed again if the firmware updating component still exists in the removable memory device after the electronic apparatus is rebooted. In other words, if the firmware updating component still exists in the removable memory device rather than being deleted after the electronic apparatus is rebooted, the firmware updating procedure will be repeatedly performed until successfully finished. As a result, the electronic apparatus can be actively rescued after the failure of the firmware updating procedure occurs by using the firmware updating method of the disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. A firmware updating method for updating a main firmware component of an electronic apparatus electrically connected with a removable memory device, the method comprising:
(a) performing a firmware updating procedure to copy a firmware updating component from the removable memory device to the electronic apparatus, and to update the main firmware component by using the firmware updating component in the removable memory device;
(b) deleting the firmware updating component and then rebooting the electronic device if the firmware updating procedure is successfully finished, or directly rebooting the electronic device if the firmware updating procedure is unsuccessfully finished;
(c ) determining whether the firmware updating component exists in the removable memory device after rebooting the electronic apparatus; and
(d) sequentially performing the steps (a) to (e) again if the firmware updating component exists in the removable memory device in the step (c).

2. The method of claim 1, wherein the step (b) further comprising:
rebooting the electronic apparatus based on the updated main firmware component if the firmware updating procedure is successfully finished.

3. The method of claim 1, wherein the step (b) further comprising:
rebooting the electronic apparatus based on the copied firmware updating component if the firmware updating procedure is unsuccessfully finished,

4. The method of claim 1, wherein the electronic apparatus is rebooted automatically if the firmware updating procedure is successfully finished, and the electronic apparatus is rebooted manually if the firmware updating procedure is unsuccessfully finished.

5. The method of claim 1 , wherein the removable memory device is a flash memory card or an external hard drive,

6. A firmware updating method for updating a main firmware component of an electronic apparatus electrically connected with a removable memory device, the method comprising:
(a) performing a firmware updating procedure to update the main firmware component by using a firmware updating component in the removable memory device;
(b) deleting the firmware updating component and then rebooting the electronic device if the firmware updating procedure is successfully finished, or directly rebooting the electronic device if the firmware updating procedure is unsuccessfully finished;
(c) determining whether the firmware updating component exists in the removable memory device after rebooting the electronic apparatus; and
(d) sequentially performing the steps (a) to (c) again if the firmware updating component exists in the removable memory device in the step (c).

7. The method of claim 6, wherein the step (b) further comprising:
rebooting the electronic apparatus based on the updated main firmware component if the firmware updating procedure is successfully finished.

8. The method of claim 6, wherein the step (b) further comprising:
rebooting the electronic apparatus based on the firmware updating component in the removable memory device if the firmware updating procedure is unsuccessfully finished.

9. The method of claim 6, wherein the electronic apparatus is rebooted automatically if the firmware updating procedure is successfully finished, and the electronic apparatus is rebooted manually if the firmware updating procedure is unsuccessfully finished.

10. An electronic apparatus, comprising:
a memory module storing a boot code component and a main firmware component; and
a processor configured to perform a firmware updating procedure to update the main firmware component by using a firmware updating component;
wherein the processor is further configured to delete the firmware updating component and then reboots the electronic device if the firmware updating procedure is successfully finished, or configured to directly rebooting the electronic device by manual means if the firmware updating procedure is unsuccessfully finished;
wherein the processor is further configured to determine whether the firmware updating component is presence after rebooting the electronic apparatus;
wherein the processor is further configured to sequentially perform the firmware updating procedure again by using the firmware updating component if the firmware updating component is presence after rebooting the electronic apparatus.

11. The electronic apparatus of claim 10, wherein the electronic apparatus is rebooted automatically if the firmware updating procedure is successfully finished, and the electronic apparatus is rebooted manually if the firmware updating procedure is unsuccessfully finished.

12. The electronic apparatus of claim 10, wherein the processor is further configured to reboot the electronic apparatus by using the boot code component which recognizes the updated main firmware component in the memory module if the firmware updating procedure is successfully finished.

13. The electronic apparatus of claim 12, wherein the firmware updating component is stored in a removable memory device, and the electronic apparatus is able to be rebooted by using the boot code component which recognizes the firmware updating component in the removable memory device when the removable memory device is connected to the electronic apparatus, and a recognizing priority level of the firmware updating component is higher than the main firmware component.

14. The electronic apparatus of claim 13, wherein the processor is further configured to reboot the electronic apparatus by using the boot code component which recognizes the firmware updating component in the removable memory device if the firmware updating procedure is unsuccessfully finished.

15. The electronic apparatus of claim 12, wherein the processor s further configured to copy the firmware updating component from a removable memory device to the electronic apparatus first when the processor performs the firmware updating procedure, so as to reboot the electronic apparatus by using the boot code component which recognizes the copied firmware updating component in the electronic apparatus if the firmware updating procedure is unsuccessfully finished.

16. The electronic apparatus of claim 15, wherein the processor is further configured to delete both the firmware updating component and the copied firmware updating component and then reboot the electronic device by using the boot code component which recognizes the updated main firmware component in the memory module if the firmware updating procedure is successfully finished.

17. The electronic apparatus of claim 16, wherein the processor is further configured to determine whether at least one of the firmware updating component and the copied firmware updating component is presence after rebooting the electronic apparatus.

18. The electronic apparatus of claim 17, wherein the processor is further configured to sequentially perform the firmware updating procedure again by using the firmware updating component if at least one of the firmware updating component and the copied firmware updating component is presence after rebooting the electronic apparatus.

19. The electronic apparatus of claim 15, wherein the memory module includes a first memory unit and a second memory unit, the boot code component and the main firmware component are stored in the first memory unit, and the copied firmware updating component is stored in the second memory unit.
